(19) United States
(12) Patent Application Publication
(10) Pub. No.: US 2022/0003387 A1
(43) Pub. Date: Jan. 6, 2022

(54) A LIGHTING SYSTEM

(71) Applicant: LEDIL OY, Salo (FI)

(72) Inventor: Petri LAUKKANEN, Salo (FI)

(21) Appl. No.: 17/291,434

(22) PCT Filed: Oct. 24, 2019
(86) PCT No.: PCT/FI2019/050761

§ 371 Date: May 5, 2021

(30) Foreign Application Priority Data
Nov. 7, 2018 (FI) 20185946

(51) Int. Cl. F21V 17/16; F21V 5/04; F21V 7/04

(52) U.S. Cl. CPC F21V 17/16; F21V 7/04; F21V 5/04

(57) ABSTRACT

A lighting system includes a substrate element, one or more light sources mounted on a surface of the substrate element, and an optical device for modifying light distribution. The lighting system further includes one or more fastening elements each being attached on the surface of the substrate element and including at least one spring arm for elastically engaging the optical device to hold the optical device in place. The optical device includes one or more apertures and each fastening element is arranged to protrude through a corresponding aperture of the optical device, and the at least one spring arm of the fastening element is arranged to elastically engage edges of the corresponding aperture of the optical device.

### FIELD OF THE DISCLOSURE

The disclosure relates generally to illumination engineering. More particularly, the disclosure relates to a lighting system comprising a substrate element, a light source mounted on the substrate element, and an optical device mounted on the substrate element and arranged to modify a distribution of light emitted by the light source.

### BACKGROUND

A distribution of light produced by a light source can be important or even critical in some applications. The light source may comprise for example one or more light emitting diodes “LED”, one or more filament lamps, or one or more gas-discharge lamps. The distribution of light produced by a light source can be modified with optical elements such as lenses, reflectors, and combined lens-reflector elements that comprise portions which act as lenses and portions which act as reflectors. In many cases, a lighting system comprises a substrate element e.g. a circuit board, a light source mounted on the substrate element, and an optical device mounted on the substrate element and arranged to modify the distribution of light emitted by the light source. The light source, e.g. a LED, is typically furnished on the substrate on a production line. The light source can be for example a surface mounted device “SMD” that is soldered to connector pads on a surface of the substrate element.

Concerning the optical device, there is often a need that the optical device is attached to the substrate somewhere else than on the production line. Furthermore, there can be a need that the optical device is a replaceable component that is non-destructively changeable so that changing the optical device does not require destructive actions such as e.g. detaching solder of glue joints.

A known approach to fasten an optical device to a substrate is based on screws so that the optical device has screw-holes and threaded parts of the screws engage respective holes of the substrate. An inconvenience related to the screw fastening is that installing the screws can be laborious and time consuming. Furthermore, in conjunction with some substrate elements e.g. a thin circuit board, it can be challenging to arrange holes whose walls are sufficiently strong for safely engaging the threaded parts of the screws.

Publication EP1959505 describes a lighting system that comprises a substrate element, a light source mounted on the substrate element, and a lens for modifying a distribution of light emitted by the light source. The lighting system further comprises a fastening element soldered on the substrate element and comprising spring arms elastically engaging the outer perimeter of the lens. An advantage of the fastening arrangement described in EP1959505 is that the lens can be quickly and easily installed on the lighting system by pushing the lens against the fastening element. It is however challenging to use the fastening arrangement described in EP1959505 in cases where there is a plate comprising e.g. an array of lens sections because the plate can be wide and/or long and thus it is challenging to elastically engage the outer perimeter of the plate with spring arms of a fastening element.

### SUMMARY

The following presents a simplified summary in order to provide basic understanding of some aspects of various embodiments of the invention. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

In this document, the word “geometric” when used as a prefix means a geometric concept that is not necessarily a part of any physical object. The geometric concept can be for example a geometric point, a straight or curved geometric line, a geometric plane, a non-planar geometric surface, a geometric space, or any other geometric entity that is zero, one, two, or three dimensional.

In accordance with the invention, there is provided a new lighting system that comprises:
a substrate element,
one or more light sources mounted on a surface of the substrate element, and
an optical device for modifying a distribution of light emitted by the one or more light sources.

The lighting system further comprises one or more fastening elements each being attached on the surface of the substrate element and comprising at least one spring arm for elastically engaging the optical device to hold the optical device in place. The optical device comprises one or more apertures and each fastening element is arranged to protrude through a corresponding one of the one or more apertures of the optical device, and the at least one spring arm of the fastening element is arranged to elastically engage edges of the corresponding aperture of the optical device.

As the one or more fastening elements are arranged to engage the edges of the one or more apertures of the optical device, the above-described fastening arrangement is suitable for cases where the optical device is a wide and/or long plate comprising a plurality of optical sections, e.g. lens sections, for modifying a distribution of light emitted by a plurality of light sources.

The above-mentioned substrate element can be for example a circuit board comprising electric conductors for supplying electricity to the one or more light sources. It is also possible that the substrate element is a heat sink element made of e.g. aluminum and there are electrically insulated wires for supplying electricity to the one or more light sources. Each light source can be for example a single light emitting diode “LED” or a group of LEDs.

Exemplifying and non-limiting embodiments of the invention are described in accompanied dependent claims.

Various exemplifying and non-limiting embodiments of the invention both as to constructions and to methods of operation, together with additional objects and advantages thereof, will be best understood from the following description of specific exemplifying embodiments when read in connection with the accompanying drawings.

The verbs “to comprise” and “to include” are used in this document as open limitations that neither exclude nor require the existence of also un-recited features.

The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF THE FIGURES

Exemplifying and non-limiting embodiments of the invention and their advantages are explained in greater detail below with reference to the accompanying drawings, in which:

FIGS. 1a and 1b illustrate a lighting system according to an exemplifying and non-limiting embodiment,

FIGS. 1c , 1d, and 1e illustrate a fastening element of the lighting system shown in FIGS. 1a and 1b,

FIG. 2 illustrates a lighting system according to an exemplifying and non-limiting embodiment,

FIG. 3 illustrates a lighting system according to an exemplifying and non-limiting embodiment,

FIGS. 4a, 4b, and 4c illustrate a lighting system according to an exemplifying and non-limiting embodiment,

FIGS. 5a, 5b, and 5c illustrate a lighting system according to an exemplifying and non-limiting embodiment,

FIG. 5d illustrates a lighting system according to an exemplifying and non-limiting embodiment, and

FIGS. 5e shows a fastening element of a lighting system according to an exemplifying and non-limiting embodiment.

### DESCRIPTION OF EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

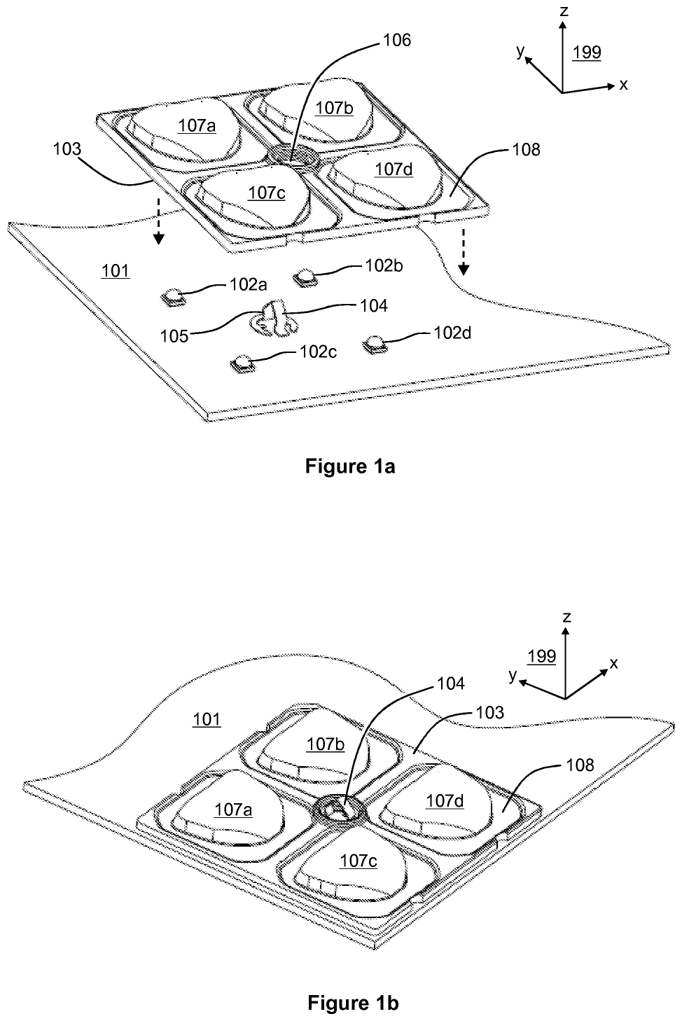

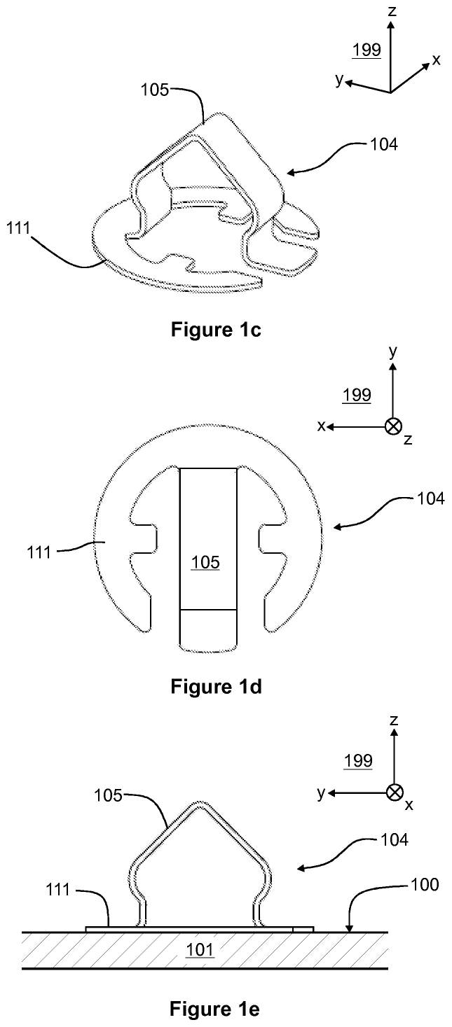

FIGS. 1a and 1b illustrate a lighting system according to an exemplifying and non-limiting embodiment. FIG. 1a shows an exploded view of the lighting system. The lighting system comprises a substrate element 101, four light sources 102a, 102b, 102c, and 102d, and an optical device 103 for modifying a distribution of light emitted by the light sources 102a-102d. The light sources can be for example light emitting diodes “LED”. In this exemplifying case, the substrate element 101 is a circuit board that comprises electric conductors for supplying electricity to the light sources 102a-102d. The light sources can be for example surface mounted devices “SMD” that are soldered to connector pads on a surface of the substrate element 101. The lighting system further comprises a fastening element 104 that is attached on the surface of the substrate element 101. The fastening element 104 comprises a spring arm 105 for elastically engaging the optical device 103 to hold the optical device in place. The optical device 103 comprises an aperture 106, and the fastening element 104 is arranged to protrude through the aperture 106 as illustrated in FIG. 1b. The spring arm 105 of the fastening element 104 is arranged to elastically engage the edges of the aperture 106 of the optical device 103.

The above-mentioned fastening element 104 is illustrated in more details in FIGS. 1c, 1d, and 1e. A coordinate system 199 illustrate the viewing directions related to FIGS. 1c-1e. In this exemplifying case, the fastening element 104 is made of a sheet of metal so that the fastening element comprises a planar section 111 attached on the surface of the substrate element 101 and a strip section constituting the spring arm 105. It is also possible that a fastening element of a lighting system according to an exemplifying and non-limiting embodiment is made of for example plastic or some other suitable non-metallic flexible material. The planar section 111 of the fastening element 104 can be attached to the surface of the substrate element 101 for example with a solder joint or with glue. In this exemplifying case, the strip section constituting the spring arm 105 is bent to have an arrow-head form that points away from the substrate 111 and is capable of flexing in a direction parallel with the surface of the substrate 101, i.e. in the y-direction of the coordinate system 199. The arrow-head form facilitates mounting the optical device 103 on the surface of the substrate 101. The optical device 103 may further comprise one or more locating pins on its bottom surface and the substrate element 101 may comprise corresponding locating holes for receiving the locating pins. The locating pins and the locating holes are not shown in FIGS. 1a and 1b. The planar section 111 of the fastening element 104 is advantageously rotationally non-symmetric so that e.g. a machine vision can recognize a rotational orientation of the fastening element 104 when the planar section 111 is on the surface of the substrate element 101. In this exemplifying case, the planar section 111 has projections on its inner periphery.

In the exemplifying lighting system illustrated in FIGS. 1a and 1b, the optical device 103 is a piece of transparent material and the optical device 103 comprises four optical sections 107a, 17b, 107c, and 107d for modifying the distribution of the light emitted by the light sources 102a-102d. In this exemplifying case, the optical sections 107a-107d are lenses. It is however also possible that each optical section is a reflector based on total internal reflection “TIR”. Furthermore, it is also possible that an optical section is a combined lens-reflector that comprises portions which act as a lens and portions which act as a reflector. The above-mentioned transparent material can be for example acrylic plastic, polycarbonate, optical silicone, or glass. The method of manufacture of the optical device 103 can be for example mold casting. The optical device 103 further comprises a flange section 108 that surrounds the optical sections 107a-107d and comprises the aperture 106 for the fastening element 104. In this exemplifying case, the optical sections 107a-107d are arranged to constitute a 2×2-array having rows in first and second directions perpendicular to each other and parallel with the surface of the substrate. In FIGS. 1a and 1b, the above-mentioned first and second directions are the x- and y-directions of the coordinate system 199. As shown in FIGS. 1a and 1b, the aperture 106 is located at the center of the optical device 103 between the x-directional rows of the 2×2-array and between the y-directional rows of the 2×2-array.

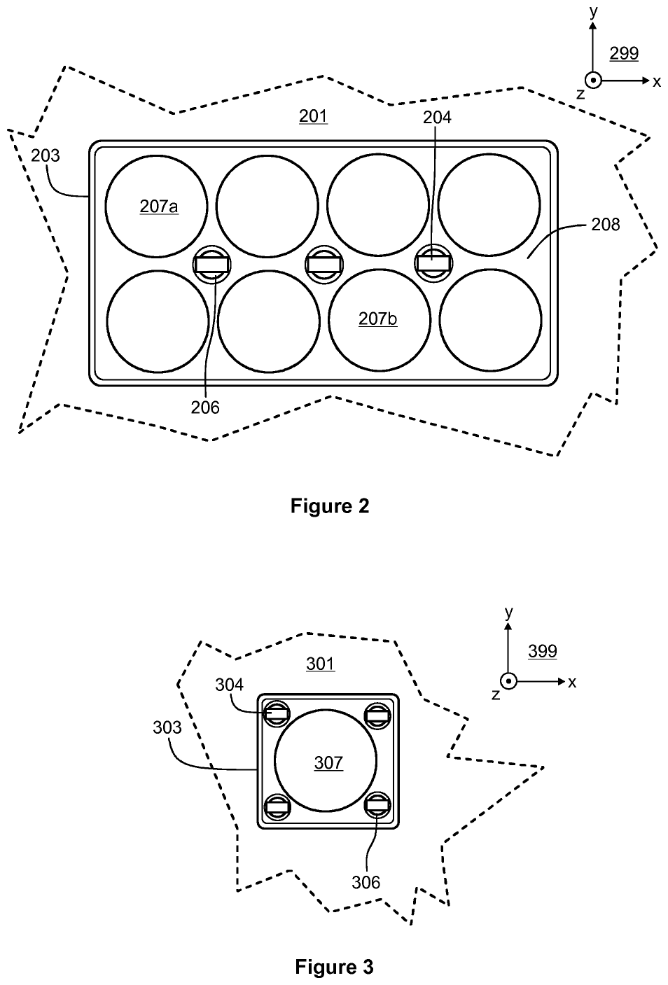

FIG. 2 shows a lighting system according to an exemplifying and non-limiting embodiment. The lighting system comprises a substrate element 201, eight light sources mounted on a surface of the substrate element, and an optical device 203 for modifying a distribution of light emitted by the light sources. The light sources are not shown in FIG. 2. The optical device 203 is a piece of transparent material and comprises optical sections for modifying the distribution of the light. In FIG. 2, two of the optical sections are denoted with references 207a and 207b . Each optical section can be for example a lens whose optical axis is parallel with the z-axis of a coordinate system 299. In this exemplifying case, the optical sections are arranged to constitute a 2×4-array having rows in x- and y-directions of the coordinate system 299. The lighting system further comprises three fastening elements attached on the surface of the substrate element 201. In FIG. 2, one of the fastening elements is denoted with a reference 204. The fastening elements can be for example such as the fastening element 104 shown in FIGS. 1 a-1 e. The optical device 203 comprises apertures, and the fastening elements are arranged to protrude through the apertures as illustrated in FIG. 2. One of the apertures is denoted with a reference 206. As shown in FIG. 2, each of the apertures is located between the x-directional rows of the 2×4-array and between adjacent ones of the y-directional rows of the 2×4-array. The fastening elements are arranged to engage the edges of the apertures of the optical device 203 to hold the optical device in place.

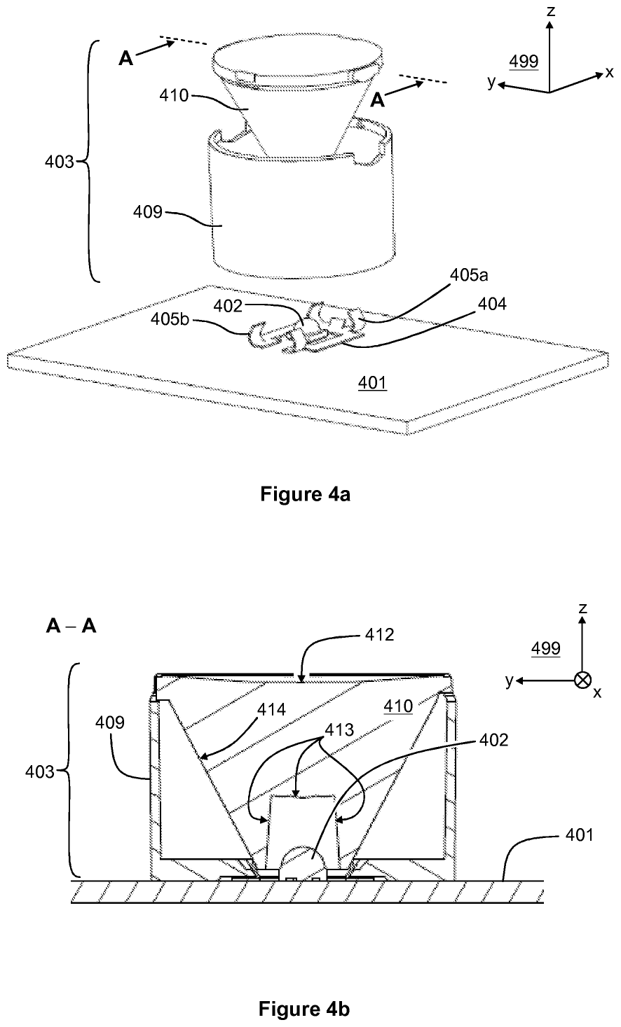

FIG. 3 shows a lighting system according to an exemplifying and non-limiting embodiment. The lighting system comprises a substrate element 301, a light source mounted on a surface of the substrate element, and an optical device 303 for modifying a distribution of light emitted by the light source. The light source is not shown in FIG. 3. The optical device 303 is a piece of transparent material and comprises an optical section 307 for modifying the distribution of the light. The optical section can be for example a lens whose optical axis is parallel with the z-axis of a coordinate system 399. The lighting system further comprises four fastening elements attached on the surface of the substrate element 301. In FIG. 3, one of the fastening elements is denoted with a reference 304. The fastening elements can be for example such as the fastening element 104 shown in FIGS. 1a-1e. The optical device 303 comprises apertures, and the fastening elements are arranged to protrude through the apertures as illustrated in FIG. 3. One of the apertures is denoted with a reference 306. The fastening elements are arranged to engage the edges of the apertures of the optical device 303 to hold the optical device in place.

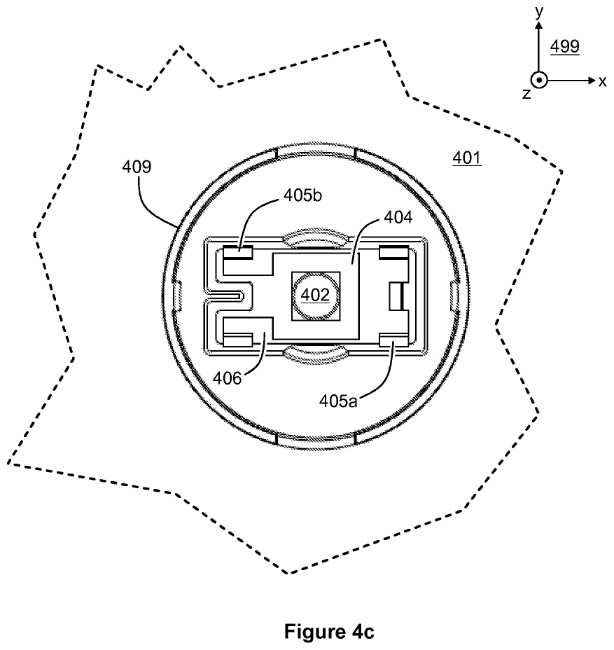

FIGS. 4a and 4b illustrate a lighting system according to an exemplifying and non-limiting embodiment. FIG. 4a shows an exploded view of the lighting system. FIG. 4b shows a view of a section taken along a line A-A shown in FIG. 4a in a situation in which the lighting system has been assembled. The section plane is parallel with the yz-plane of a coordinate system 499. The lighting system comprises a substrate element 401, a light source 402, and an optical device 403 for modifying a distribution of light emitted by the light source 402. The light source 402 can be for example a light emitting diode “LED”. The lighting system further comprises a fastening element 404 that is attached on the surface of the substrate element 401 and comprises four spring arms for elastically engaging the optical device 403 to hold the optical device in place. In FIG. 4a, two of the spring arms are denoted with references 405a and 405b.

In the exemplifying lighting system illustrated in FIGS. 4a and 4b, the optical device 403 comprises a holder element 409 and an optical element 410 attached to the holder element 409. In this exemplifying case, the optical element 410 is a combined lens-reflector that comprises surfaces 412 and 413 that act as lens portions based on refraction of light and a surface 414 that acts a reflector portion based on total internal reflection “TIR”. The holder element 409 comprises an aperture whose edges are arranged to engage the spring arms of the fastening element 404 to hold the optical device 403 in place.

FIG. 4c shows a part of the substrate element 401, the light source 402, the fastening element 404, and the holder element 409 in a situation in which the optical element 410 is missing. The viewing direction related to FIG. 4c is illustrated by the coordinate system 499. In FIG. 4c, the aperture of the holder element 409 is denoted with a reference 406. As shown in FIGS. 4b and 4c, the light source 402 is in the aperture of the holder element 409.

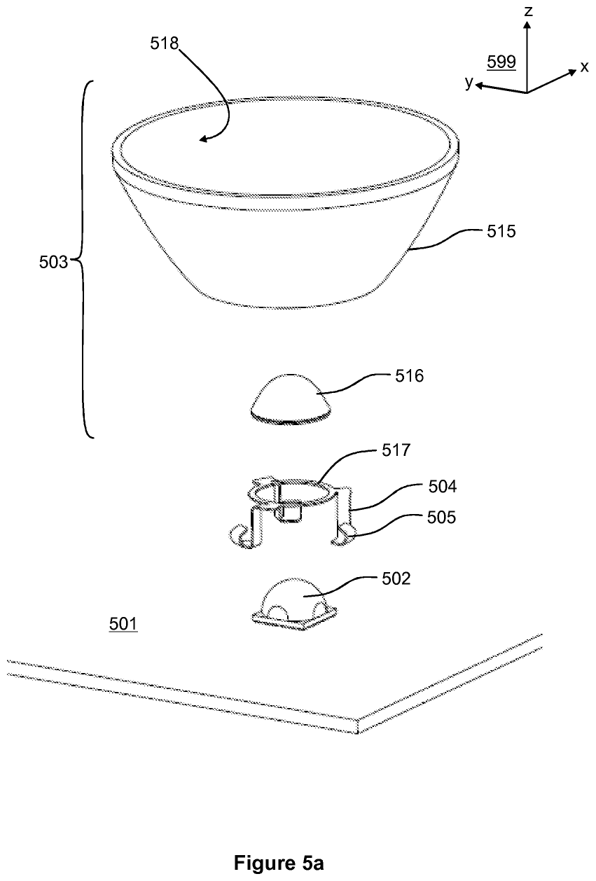

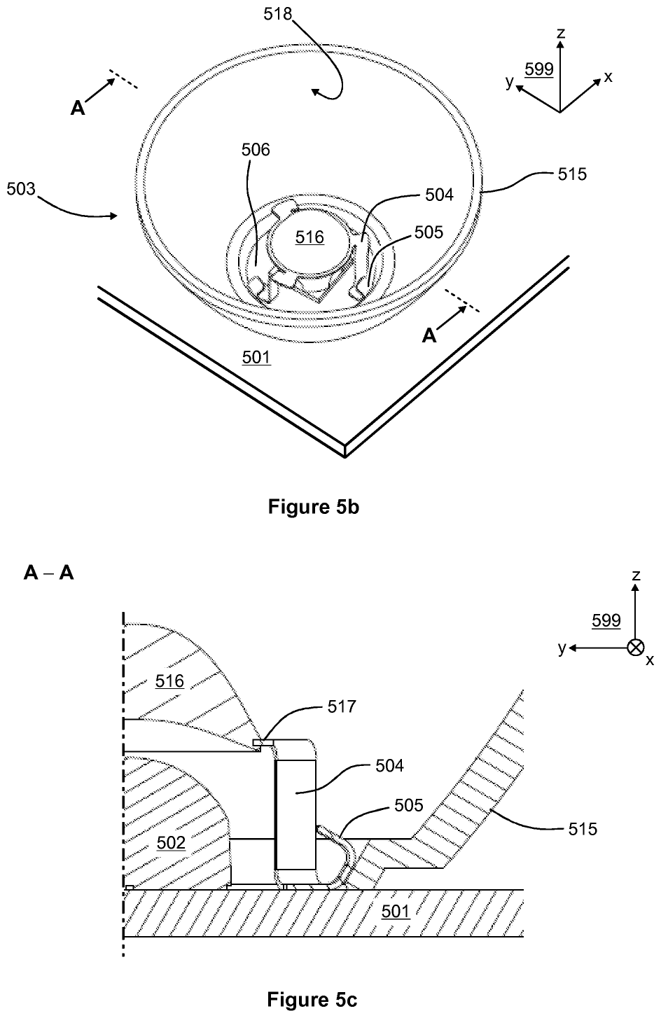

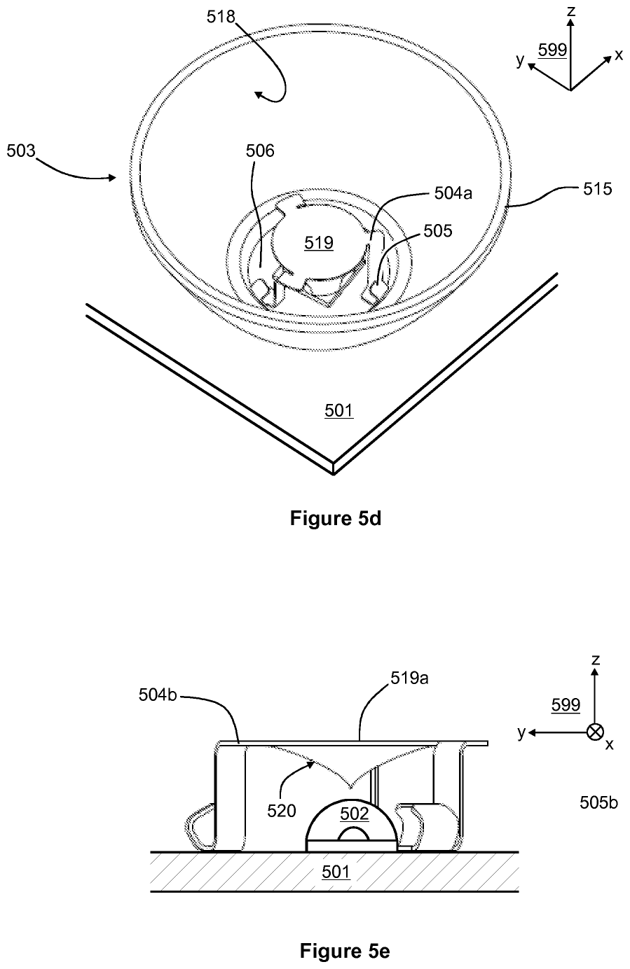

FIGS. 5a, 5b, and 5c illustrate a lighting system according to an exemplifying and non-limiting embodiment. FIG. 5a shows an exploded view of the lighting system. FIG. 5c shows a part of a section taken along a line A-A shown in FIG. 5b. The section plane is parallel with the yz-plane of a coordinate system 599. The lighting system comprises a substrate element 501, a light source 502, and an optical device 503 for modifying a distribution of light emitted by the light source. The lighting system further comprises a fastening element 504 that is attached, e.g. soldered, to a surface of the substrate element 501. The fastening element 504 comprises spring arms for elastically engaging the optical device 503 to hold the optical device in place. In FIGS. 5a-5c, one of the spring arms is denoted with a reference 505. In this exemplifying case, the fastening element 504 has three spring arms but it is also possible that there are four or more spring arms. The optical device 503 comprises a bowl-shaped reflector element 515 that comprises a reflective surface 518 that can be e.g. a metallized surface. As illustrated in FIG. 5b, the bowl-shaped reflector element 515 comprises an aperture 506 for engaging the spring arms of the fastening element 504.

In the exemplifying optical device illustrated in FIGS. 5a-5c, the fastening element 504 comprises a support structure 517 arranged to hold a transparent optical element 516 that covers the light source 502 when seen along a direction perpendicular to the surface of the substrate element 501 i.e. when seen along the negative z-direction of the coordinate system 599. In this exemplifying case, the transparent optical element 516 is a lens. For another example, a transparent optical element supported by the fastening element 504 can be a transparent plate whose one or both surfaces comprise undulations for modifying light distribution. The undulations may comprise converging and diverging deviations from a planar shape so that a surface provided with the undulations is a colour mixing surface where light beams exhibiting different wavelengths are effectively mixed thus producing a light pattern which contains evenly distributed wavelengths.

FIGS. 5d illustrates a lighting system according to an exemplifying and non-limiting embodiment. The lighting system shown in FIG. 5d is otherwise like the lighting system illustrated in FIGS. 5a-5c, but a fastening element 504a of the lighting system shown in FIG. 5d differs from the fastening element 504 shown in FIGS. 5a-5c. The fastening element 504a comprises a light impermeable cover structure 519 arranged to cover the light source 502 when seen along a direction perpendicular to the surface of the substrate element 501.

FIG. 5e shows a fastening element 504b of a lighting system according to an exemplifying and non-limiting embodiment. The lighting system is otherwise like the lighting system illustrated in FIGS. 5a-5c, but the fastening element 504b differs from the fastening element 504 shown in FIGS. 5a-5c. The fastening element 504b comprises a light impermeable cover structure 519a arranged to cover the light source 502 when seen along a direction perpendicular to the surface of the substrate element 501. A surface 520 of the light impermeable cover structure 519a that faces towards the light source 502 is shaped to reflect light sideward to the reflective surface of the bowl-shaped reflector element.

The specific examples provided in the description given above should not be construed as limiting the scope and/or the applicability of the appended claims. Lists and groups of examples provided in the description given above are not exhaustive unless otherwise explicitly stated.

1. A lighting system comprising:
a substrate element,
one or more light sources mounted on a surface of the substrate element, and
an optical device for modifying a distribution of light emitted by the one or more light sources,
wherein the lighting system further comprises one or more fastening elements each being attached on the surface of the substrate element and comprising at least one spring arm for elastically engaging the optical device to hold the optical device in place, and wherein the optical device comprises one or more apertures and each of the one or more fastening elements is arranged to protrude through a corresponding one of the one or more apertures of the optical device, and the at least one spring arm of the fastening element is arranged to elastically engage edges of the corresponding aperture of the optical device.

2. The lighting system according to claim 1, wherein the optical device is a piece of transparent material and comprises one or more optical sections for modifying the distribution of the light and a flange section surrounding the one or more optical sections and comprising the one or more apertures for the one or more fastening elements.

3. The lighting system according to claim 2, wherein the optical sections are arranged to constitute rows in first and second directions perpendicular to each other and parallel with the surface of the substrate, and each of the one or more apertures is located between adjacent ones of the rows that are in the first direction and between adjacent ones of the rows that are in the second direction.

4. The lighting system according to claim 2, wherein each optical section is a lens.

5. The lighting system according to claim 1, wherein the optical device comprises a holder element comprising the one or more apertures for engaging the one or more fastening elements and an optical element attached to the holder element.

6. The lighting system according to claim 5, wherein the fastening element has two or more spring arms for elastically engaging the aperture of the holder element, and the light source is in the aperture of the holder element.

7. The lighting system according to claim 1, wherein each fastening element is made of a sheet of metal so that the fastening element comprises a planar section attached on the surface of the substrate element and at least one strip section constituting the at least one spring arm.

8. The lighting system according to claim 7, wherein the strip section is bent to have an arrow-head form pointing away from the substrate and being capable of flexing in a direction parallel with the surface of the substrate.

9. The lighting system according to claim 1, wherein the optical device comprises a bowl-shaped reflector element comprising a reflective surface and the aperture for engaging the fastening element.

10. The lighting system according to claim 9, wherein the fastening element comprises a support structure arranged to hold a transparent optical element covering the light source when seen along a direction perpendicular to the surface of the substrate element.

11. The lighting system according to claim 9, wherein the fastening element comprises a light impermeable cover structure arranged to cover the light source when seen along a direction perpendicular to the surface of the substrate element.

12. The lighting system according to claim 11, wherein a surface of the light impermeable cover structure facing towards the light source is shaped to reflect light sideward to the reflective surface of the bowl-shaped reflector element.

13. The lighting system according to claim 1, wherein the one or more fastening elements are attached on the surface of the substrate element with solder joints.

14. The lighting system according to claim 1, wherein the one or more fastening elements are attached on the surface of the substrate element with glue.

15. The lighting system according to claim 1, wherein substrate element is a circuit board comprising electric conductors for supplying electricity to the one or more light sources.

16. The lighting system according to claim 3, wherein each optical section is a lens.

17. The lighting system according to claim 2, wherein each fastening element is made of a sheet of metal so that the fastening element comprises a planar section attached on the surface of the substrate element and at least one strip section constituting the at least one spring arm.

18. The lighting system according to claim 3, wherein each fastening element is made of a sheet of metal so that the fastening element comprises a planar section attached on the surface of the substrate element and at least one strip section constituting the at least one spring arm.

19. The lighting system according to claim 4, wherein each fastening element is made of a sheet of metal so that the fastening element comprises a planar section attached on the surface of the substrate element and at least one strip section constituting the at least one spring arm.

20. The lighting system according to claim 5, wherein each fastening element is made of a sheet of metal so that the fastening element comprises a planar section attached on the surface of the substrate element and at least one strip section constituting the at least one spring arm.
